(19) United States
(12) Patent Application Publication
(10) Pub. No.: US 2005/0259974 A1
(43) Pub. Date: Nov. 24, 2005

(54) Data reproduction apparatus and data reproduction method

(76) Inventors: Takashi Karimoto, Kanagawa (JP); Tomoko Kadota, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/126,807

(22) Filed: May 11, 2005

(30) Foreign Application Priority Data
May 13, 2004 (JP) P2004-143961

(51) Int. Cl. H04N 5/781

(52) U.S. Cl. 386/111; 386/125

(57) ABSTRACT

Special reproduction of image data of field precision is made possible without using a dedicated data decoding means and increasing the buffer capacity. The present invention provides a data reproduction apparatus that includes an acquisition section that acquires digital video data, a temporary memory section that temporarily stores the digital video data acquired by the acquisition section on a frame by frame basis, an output frame generation control section that generates the output frames to be output, following the output of the original frames of the digital video data stored in the temporary memory section, by rewriting the auxiliary data contained in the digital video data and specifying the output image data, a data decoding section that decodes the digital video data according to the auxiliary data, and an output section that externally outputs the digital video data decoded by the data decoding section.

### CROSS REFERENCES TO RELATED APPLICATIONS

The present invention contains subject matter related to Japanese Patent Application JP 2004-143961 filed in Japanese Patent Office on May 13, 2004, the entire contents of which being incorporated herein by reference.

### BACKGROUND OF THE INVENTION

1. Field of the Invention

This invention relates to a data reproduction apparatus and a data reproduction method. More particularly, the present invention relates to a data reproduction apparatus and a data reproduction method for reproducing DV (digital video) data.

2. Description of the Related Art

Since known reproduction apparatus for reproducing DV data stream recorded by means of a digital video camera generally employ a special reproduction system that relies on frame precision, reproduced moving images move remarkably clumsily particularly when the apparatus is operated for special reproduction such as slow reproduction and fast forward reproduction, of which slow reproduction is particularly accompanied by clumsy moves. For this reason, when a special reproduction system that relies on field precision is employed in order to improve the precision of the reproduced image, either a technique of using a DV data reproduction apparatus having a feature of being capable of externally selecting an output field or a technique of utilizing a dedicated DV codec having a feature of realizing special reproduction that relies on field precision by way of rewrite and stream control of auxiliary data describing information on data according to a selected mode is used. In the case of the technique of using a DV codec, however, it is necessary to issue a command to the DV codec and control the transmission of a stream to the DV codec simultaneously. Therefore, the special reproduction that relies on field precision is a technique that is feasible for limited apparatus.

A similar situation arises when dealing with MPEG video signals conforming to the MPEG Standards that define general purpose video data formats. Techniques for rewriting control data that define the sequence of displaying pictures have been proposed for the purpose of decoding MPEG streams for special reproduction by means of an existing decoder (see, inter alia, Japanese Patent Application Laid-Open Publication No. 2002-077815).

### SUMMARY OF THE INVENTION

In view of the above-identified circumstances, it is desirable to provide a data reproduction apparatus and a data reproduction method that can realize special reproduction relying on field precision by means of a known decoder without arranging a special codec or increasing the buffer capacity.

According to the present invention, the above object is achieved by providing a data reproduction apparatus comprising: an acquisition means for acquiring digital video data; a temporary memory means for temporarily storing the digital video data acquired by the acquisition means on a frame by frame basis; an output frame generation control means for generating the output frames to be output, following the output of the original frames of the digital video data stored in the temporary memory means, by rewriting the auxiliary data contained in the digital video data and specifying the output image data; a data decoding means for decoding the digital video data according to the auxiliary data; and an output means for externally outputting the digital video data decoded by the data decoding means.

The output frame generation control means generates the output frames, following the output of the original frames, by rewriting the auxiliary data of the original frames stored in the temporary memory means.

Preferably, the output frame generation control means copies the original frames in the temporary memory means and generates the output frames by rewriting the auxiliary data contained in the original frames and the frames obtained by the copying. The output frame generation control means may generate the output frames by rewriting sequentially from the sequence already output to the data decoding means out of the plurality of sequences of the original frames for the sequences of the frames to be output following the original frames. In these cases, the output frame generation control means rewrites a predetermined bit that describes information for determining the field type of the output image data. As a result, the frames specified in the auxiliary data are generated.

According to the present invention, there is provided a data reproduction method comprising: a step of acquiring digital video data; an output frame generation control step of generating the output frames to be output, following the output of the original frames of the digital video data stored in a temporary memory means for temporarily storing the digital video data acquired in the acquisition step on a frame by frame basis, by rewriting the auxiliary data contained in the digital video data and specifying the output image data; a data decoding step of decoding the digital video data according to the auxiliary data; and an output step of externally outputting the digital video data decoded in the data decoding step.

The output frame generation control step is adapted to generate the output frames, following the output of the original frames, by rewriting the auxiliary data of the original data stored in the temporary memory means.

Preferably, the output frame generation control step is adapted to copy the original frames in the temporary memory means and generates the output frames by rewriting the auxiliary data contained in the original frames and the frames obtained by the copying. The output frame generation control step may be adapted to generate the output frames by rewriting sequentially from the sequence already output in the data decoding step out of the plurality of sequences of the original frames for the sequences of the frames to be output following the original frames. In these cases, the output frame generation control step is adapted to rewrite a predetermined bit that describes information for determining the field type of the output image data. As a result, the frames specified in the auxiliary data are generated.

Thus, according to the invention, it is possible to realize special reproduction of field precision by means of a general purpose data reproduction processing section without using a data reproduction processing section having a special feature of field precision. It is also possible to realize special reproduction of field precision without raising the buffer size. As a result, the image quality of the reproduced image in a special reproduction mode is improved. Additionally, it is possible to respond quickly to a request for switching reproduction modes and realize the specified reproduction.

### BRIEF DESCRIPTION OF THE DRAWINGS

FIG. 1 is a schematic block diagram of an embodiment of data reproduction apparatus according to the invention;

FIG. 2 is a schematic illustration of the data format of AUX data;

FIG. 3 is another schematic illustration of the data format of AUX data;

FIG. 4 is still another schematic illustration of the data format of AUX data;

FIG. 5 schematically illustrates a processing operation of the embodiment of data reproduction apparatus of FIG. 1 for copying a frame and rewriting AUX data;

FIG. 6A is a schematic illustration of the DV frame after rewriting the AUX data to be transmitted to the data reproduction processing section and the DV data decoded by the data reproduction processing section and transmitted to the DAC when the slow reproduction speed is equal to the quotient obtained by dividing the speed of normal reproduction by an even number;

FIG. 6B is a schematic illustration of the timing for the stream controller to input the DV frame to the data reproduction processing section and the timing for the decoded DV data to be output to the DAC;

FIG. 7A is a schematic illustration of the DV frame after rewriting the AUX data to be transmitted to the data reproduction processing section and the DV data decoded by the data reproduction processing section and transmitted to the DAC when the slow reproduction speed is equal to the quotient obtained by dividing the speed of normal reproduction by an odd number;

FIG. 7B is a schematic illustration of the timing for the stream controller to input the DV frame to the data reproduction processing section and the timing for the decoded DV data to be output to the DAC;

FIG. 8A is a schematic illustration of the DV frame after rewriting the AUX data to be transmitted to the data reproduction processing section and the DV data decoded by the data reproduction processing section and transmitted to the DAC when a temporary stop mode is selected;

FIG. 8B is a schematic illustration of the timing for the stream controller to input the DV frame to the data reproduction processing section and the timing for the decoded DV data to be output to the DAC;

FIG. 9 is a schematic illustration showing how data are thinned by the system controller from the DV data stream transmitted from a storage device so as to be used for fast reproduction;

FIG. 10A is a schematic illustration of the DV frame after rewriting the AUX data to be transmitted to the data reproduction processing section and the DV data decoded by the data reproduction processing section and transmitted to the DAC when a fast reproduction mode is selected;

FIG. 10B is a schematic illustration of the timing for the stream controller to input the DV frame to the data reproduction processing section and the timing for the decoded DV data to be output to the DAC;

FIG. 11 is a schematic illustration showing how the stream controller moves from a fast reproduction mode to a normal reproduction mode from the DV data stream transmitted from a storage device;

FIG. 12 is a schematic illustration of the process used by the embodiment of data reproduction apparatus of FIG. 1 for rewriting sequentially from the sequence already output to the data reproduction processing section out of the plurality of sequences of the original frames for the sequences of the frames to be output following the original frames; and

FIG. 13 is a schematic illustration of the process of transmitting the sequences generated by the process of FIG. 12.

### DETAILED DESCRIPTION OF HE PREFERRED EMBODIMENTS

An embodiment of data reproduction apparatus is an apparatus having a digital video data reproduction feature of inputting digital video data (to be referred to as DV data hereinafter) and reproducing them or outputting them to a display apparatus or some other apparatus as reproduction signals and adapted to realize special reproduction that relies on field precision by rewriting the auxiliary data describing information relating to the data output from a decoder for decoding the input DV data. The auxiliary data described in the DV data (to be referred to as AUX data hereinafter) contains information such as control information, the recording hours, the date of recording and so on.

Now, an embodiment of data reproduction apparatus according to the invention will be described in detail by referring to the accompanying drawings.

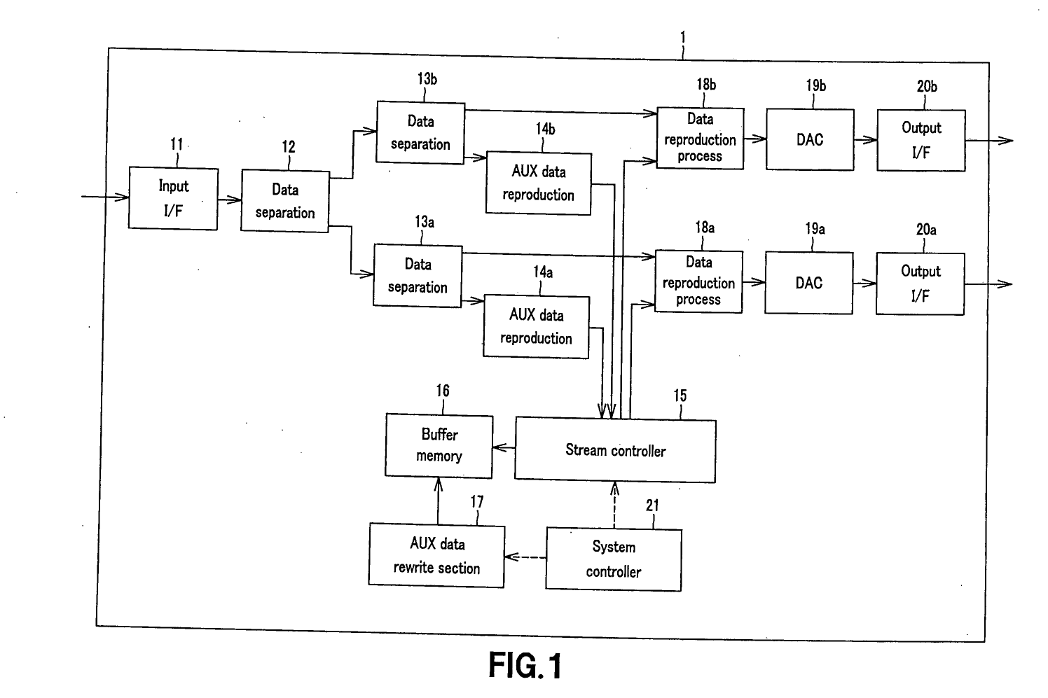

The data reproduction apparatus 1 of this embodiment illustrated in FIG. 1 comprises an input interface 11 that operates as a DV data acquisition section, a data separating section 12 for separating the input DV data into video data and audio data, a data separating section 13 for separating real data and the auxiliary data (to be referred to as AUX data hereinafter) that accompany the real data, an AUX data reproducing section 14 for reproducing the AUX data, a stream controller 15 for controlling the stream of the input DV data, a buffer memory 16 that provides a working area for the stream controller, an AUX data rewriting section 17 for rewriting the AUX data, a data reproduction processing section 18 that operates for decoding the DV data, a DAC (digital to analog converter) 19 for converting the decoded DV data by digital/analog conversion and an output interface 20 for externally outputting the data decoded by the data reproduction processing section. These component sections of the apparatus are collectively controlled by a system controller 21. As for the components in FIG. 1 that are denoted by the same numerical symbol but prefixed by a and b, a refers to a component for video data while b refers to a component for audio data.

The input interface 11 inputs a data stream of DV data transmitted from a storage device that can record DV data such as a DV tape or an HDD as an input destination of DV data. The data separating section 12 separates the input DV data into video data and audio data. Of the DV data separated by the data separating section 12, the video data are supplied to the data separating section 13a, while the audio data are supplied to the data separating section 13b. Both the video data and the audio data are accompanied by AUX data and parities.

The data separating section 13 executes an error correction process, using the parities, and separates real data and the AUX data that accompany the real data. More specifically, the data separating section 13a separates real data and the VAUX (video auxiliary) data that accompany the real data as auxiliary data of the video data. VAUX data can be used to describe channel numbers, the category of black and white or color, the source code, the channel category, the recording hours, the date of recording and other pieces of information.

The real data of the video data are supplied to the stream controller 15 and the data reproduction processing section 18a. The separated VAUX data are supplied to the AUX data reproducing section 14a. The AUX data reproducing section 14a reproduces the VAUX data that are auxiliary data of the video data. The reproduced VAUX data are supplied to the stream controller 15 so as to be used as control data for data decoding and other purposes.

The buffer memory 16 has a capacity for storing VAUX data of at least a frame and is used as the working area of the stream controller. The AUX data rewriting section 17 specifies either a top field or a bottom field for the data, or the field, to be output from the data reproduction processing section 18 by rewriting a predetermined bit under the control of the system controller 21. The processing operation of the stream controller 15 and the AUX data rewriting section 17 for rewriting the predetermined bit of the input DV data will be described in greater detail hereinafter.

The data reproduction processing section 18a is adapted to execute a process of decompressing the reproduced compressed data by way of decoding of the two-dimensional Huffman code, inverse quantization and inverse DCT. The data reproduction processing section 18a is also adapted to execute a deblocking process and a deshuffling process. The data reproduction processing section 18a outputs digital component video data including a luminance signal Y and color difference signals R-Y and B-Y The digital component video data are supplied to the DAC 19a.

The DAC 19a converts the digital component video data into analog component video data. The analog component video data obtained by the conversion are output from the output interface 20a. When a composite signal is output, a luminance signal Y and color difference signals R-Y and B-Y are synthesized and a synchronizing signal is added before it is output. The DV data output from the output interface 20a are transmitted to a monitor that displays an image to be viewed by the user.

On the other hand, the audio data from the data separating section 12 are supplied to the data separating section 13b. The audio data supplied to the data separating section 13b are accompanied by auxiliary data and parities. The data separating section 13b executes an error correction process, using the parities, and separates real audio data and the AAUX (audio auxiliary) data that are auxiliary data of the audio data. Information such as specification of the channel category of 2-channel or 4-channel, the sampling frequency, use or nonuse of emphasis, the recording hours and the date of recording can be described in AAUX data.

The audio data are then supplied to the data reproduction processing section 18b. The separated AAUX data are supplied to the AUX data reproducing section 14b. The AUX data reproducing section 14b reproduces the AAUX data. The reproduced AAUX data are supplied to the stream controller 15 and the data reproduction processing section 18b.

The data reproduction processing section 18b executes an audio data reproduction process. The AAUX data reproduced by the AUX data reproducing section 14b are used as control data. The data reproduction processing section 18b outputs digital audio data. The digital audio data are then supplied to the DAC 19b. The DAC 19b converts the digital audio data into analog audio data and the analog audio data obtained by the conversion are output from the output interface 20b.

The system controller 21 controls the stream controller 15 and the AUX data rewriting section 17 so as to realize the specified special reproduction for the output video data and also controls the components of the data reproduction apparatus 1 in a coordinated manner.

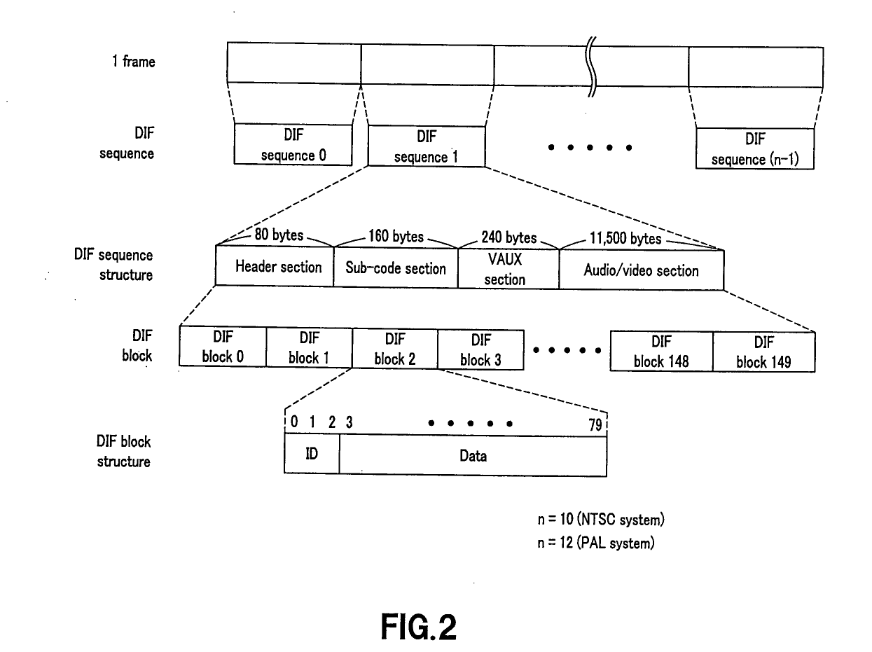

Now, the data format of auxiliary data (AUX data) that provides information relating to DV data will be described by referring to FIGS. 2 through 4.

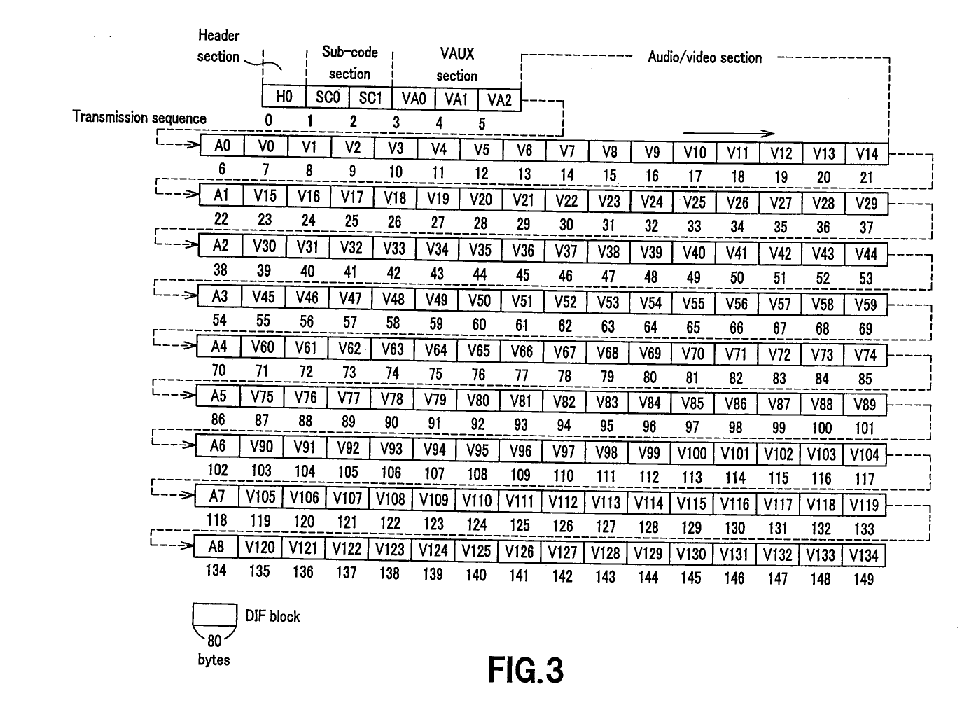

As shown in FIGS. 2 and 3, a frame of AUX data contains 120,000 bytes and is divided into 250 packets for transmission/reception. A frame of AUX data is constituted by 10 DIF sequences in the case of the NTSC system and by 12 DIF sequences in the case of the PAL system. A DIF sequence is by turn constituted by 150 DIF blocks, each containing 80 bytes. More specifically, it includes a header section of 80 bytes, sub-code sections SC0, SC1 of 160 bytes, VAUX sections VA0, VA1, VA2 of 240 bytes and an audio section and a video section of 11,500 bytes.

VAUX data are formed by using a unit of a “pack”, or a block of a fixed length of 5 bytes. A pack refers to the smallest unit of data group. A pack is formed by collecting related data. The first byte (PC0) of a pack is a header that indicates the contents of the data and the second byte (PC1) through the fifth bytes (PC4) contain data of the contents. The VAUX sections describes auxiliary data that represent information relating to the image source and information on the sound recording and the video recording, of which the information that specifies the output image data of the data reproduction processing section is described in a source control pack.

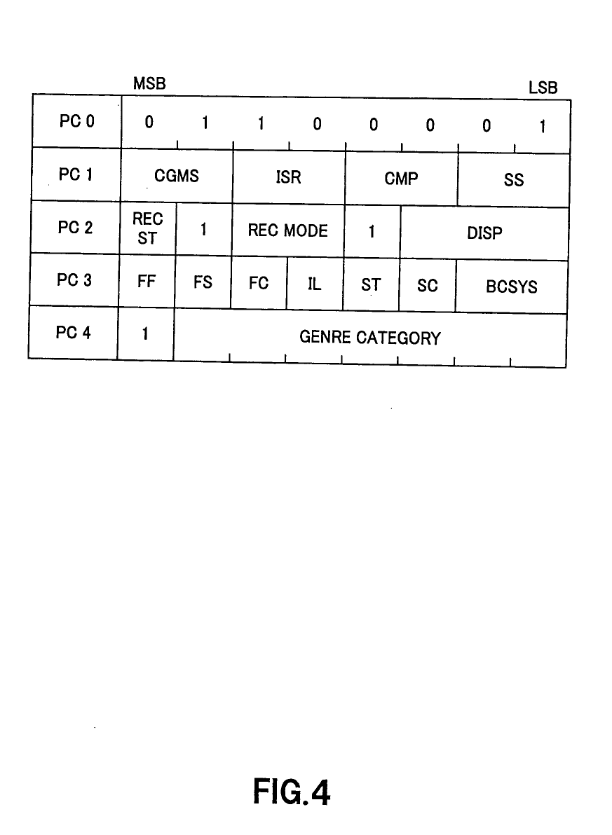

FIG. 4 illustrates the structure of a source control pack. Such a source control pack is recorded in the VAUX sections. It is specifically defined when the PC0, or the header, is “0110001”. CGMS, ISR, CMR and SS are described in the PC1. The CGMS (copy generation management system) indicates the generation capable of copying by means of “00”, “01”, “10”, “11”. The ISR (input source of just previous recording) indicates if the recording source data is digital or analog. More specifically, it indicates an analog input if it is “00b” and it indicates a digital input if it is “01b” whereas it indicates reserve if it is “10b” and it indicates no information if it is “11b”. The CMR (the number of times compression) indicates the magnitude of compression. More specifically, it indicates a single compression if it is “00b” and it indicates two compressions if it is “01b”, whereas it indicates three compressions if it is “10b” and it indicates no information if it is “11b”. The SS (source and recorded situation) indicates the source and the recorded situation. RECST (recording start point), RECMODE (recording mode) and DISP (display select mode) are described in PC2.

An FF (frame/field) flag that indicates if both a top field (first field) and a bottom field (second field) are output or either of the two fields is output twice in a frame period and an FS (first/second) flag that indicates which of the two fields is output are described in the PC3.

The field type of the image output from the data reproduction processing section 18a is determined by the combination of the FF flag and the FS flag. More specifically, if FF=1 and FS=1, the top field (the first field) and the bottom field (the second field) are output in the mentioned order. If FF=1 and FS=0, the bottom field and the top field are output in the mentioned order. If FF=0 and FS=1, the top field is output twice. If FF=0 and FS=0, the bottom field is output twice. Normally, the FF flag and the FS flag in AUX data are FF=1 and FS=1, the data reproduction processing section outputs the top field (the first field) and subsequently the bottom field (the second field).

Additionally, an FC (frame change) flag that indicates if the image of the current frame is same as that of the immediately preceding frame or not, an IL (interlace) flag that indicates if the data of the two field in a frame are interlaced or not, an ST (still-field picture) flag that indicates the time interval between the fields in a frame, an SC (still camera picture) flag that indicates if the image is a still image or not and BCSYS (broadcast system) are described in the PC3. The display size is defined by the DISP and the BCSYS. GENRE CATEGORY that indicates the category of the video source is described in the PC4. A detail of GENRE CATEGORY is described in a timer act date pack.

It is so determined that the above described source control pack is recorded in VA0 if the DIF sequence has an odd number and in VA2 if the DIF sequence has an even number. The FF flag and the FS flag correspond to the leading bit of the twelfth byte of VA0 if the DIF sequence has an odd number, whereas they correspond to the leading bit of the fifty seventh byte of VA2 if the DIF sequence has an even number.

Now, a special reproduction process of the data reproduction apparatus 1 of this embodiment will be described.

Take a process of copying the original frames in the buffer memory 16 and rewriting the AUX data contained in the original frames and the frames obtained by the copying the original frames to generate the frames to be output as a first example of reproduction process. Then, take a process of rewriting the plurality of sequences of the original frames into the sequences of the frames to be output, following the original frames, sequentially from the sequence output to the data reproduction processing section 18 as a second example of reproduction process. In the both processes, the data reproduction apparatus 1 specifies the output frame by rewriting the FF flag and the FS flag that are described above.

### SPECIFIC EXAMPLE 1-1

### When a Forward Slow Reproduction Mode is Specified in a Forward Normal Reproduction Mode

To begin with, a process of slow reproduction of field precision will be described for the first specific example. When the data reproduction apparatus 1 is switched from a forward normal reproduction mode to a forward slow reproduction mode, a process as described below may be used to rewrite AUX data in order to generate output frames.

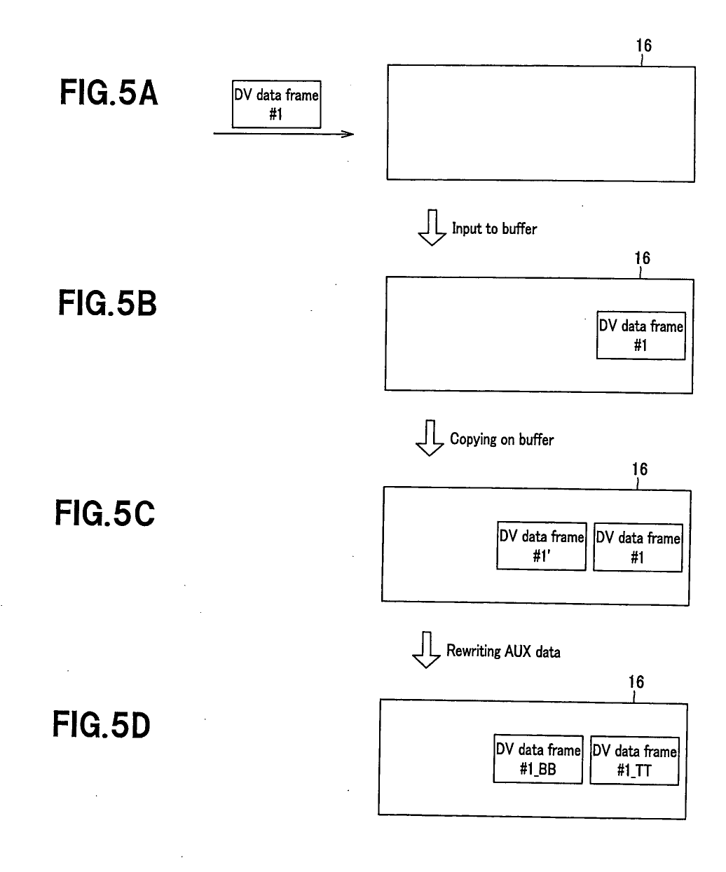

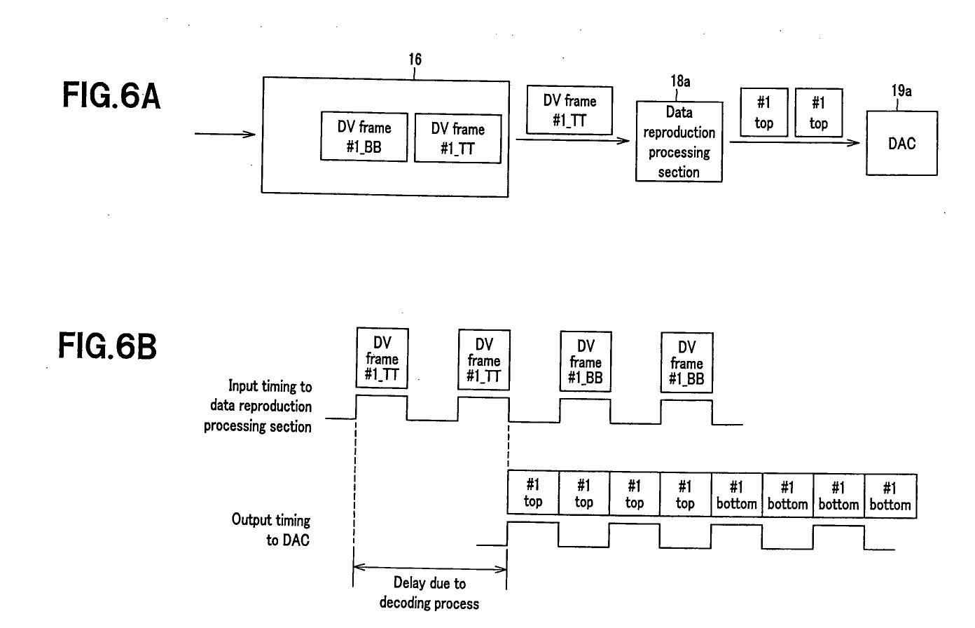

Specific Example 1-1 will be described by referring to FIGS. 5 and 6. For the convenience of description, an operation of processing a single DV frame out of a DV data stream will be discussed below. FIG. 5 schematically illustrates a processing operation for copying a frame and rewriting AUX data. The data reproduction apparatus 1 copies the DV data in the buffer memory 16 and changes the FF flag and the FS flag for specifying the output sequence for the VAUX data of the original DV data and the VAUX data of the copy DV data.

The stream controller 15 of the data reproduction apparatus 1 inputs the DV data stream transmitted from a storage device that can record DV data such as a DV tape or an HDD and put DV frame #1, which is a frame of the acquired DV data, into the buffer memory 16 under the control of the system controller 21. This step of operation is expressed as “state A→state B” in FIG. 5. The stream controller 15 prepares DV frame #1′, which is a copy of the DV frame #1 stored in the buffer memory 16, on the same buffer memory 16 as indicated by state C in FIG. 5.

Then, the AUX data rewriting section 17 rewrites the FF flag and the FS flag of the AUX data of the DV frame #1 so as to read as FF=1 and FS=1 and also the FF flag and the FS flag of the AUX data of DV frame #1′ so as to read as FF=0 and FS=0 under the control of he system controller 21 as indicated by state D in FIG. 5. In FIG. 5, the frame for which the FF flag and the FS flag of the AUX data are rewritten so as to read as FF=0 and FS=1 is expressed by “DV frame #1_TT” and the frame for which the FF flag and the FS flag are rewritten so as to read as FF=0 and FS=0 is expressed by “DV frame #1_BB”. The stream controller 15 outputs the top field twice to the data reproduction processing section 18a if the FF flag and the FS flag of the DV frame for which the DV data is input to the data reproduction processing section 18a according to the FF flag and the FS flag of the input DV frame read as FF=0 and FS=1, whereas it outputs the bottom field twice to the data reproduction processing section 18b if the FF flag and the FS flag read as FF=0 and FS=0. If the speed of slow reproduction is equal to the quotient obtained by dividing the speed of normal reproduction by an even number, the stream controller 15 is so controlled by the system controller 21 as to output either the top field or the bottom field twice in a frame period. The above-described example of FIG. 5 shows a processing operation for slow reproduction with a speed that is equal to 1/4 of the speed of normal reproduction.

Now, the DV frame obtained after rewriting the AUX data to be transmitted to the data reproduction processing section 18a and the DV data to be decoded by the data reproduction processing section 18a and transmitted to the DAC 19a when the speed of slow reproduction is equal to the quotient obtained by dividing the speed of normal reproduction by an even number will be described below by referring to FIGS. 6A and 6B.

As schematically illustrated in FIG. 6A, the data reproduction processing section 18a decodes the DV frame stored in the buffer memory 16 and transmitted from the stream controller 15 according to the FF flag and the FS flag of the VAUX data contained in the DV frame and transmits it to the DAC 19a. For example, if the DV frame is “DV frame #1_TT”, the top field is output twice because the FF flag and the FS flag of the AUX data read as FF=0 and FS=1 respectively.

If the speed of slow reproduction is equal to 1/4 of the speed of normal reproduction, the stream controller 15 reads out the “DV frame #1_TT” generated from the DV frame #1 and the “DV frame #1_BB” generated from the DV frame #1′ that is a copy of the DV frame #1 from the buffer memory 16 and outputs the “DV frame #1_TT” twice as in the example of FIG. 5. Subsequently, the stream controller 15 switches the output frame to the “DV frame #1_BB” and outputs the “DV frame #1_BB” twice.

FIG. 6B illustrates the timing for the stream controller 15 to input the DV frame to the data reproduction processing section 18a and the timing for the DV data decoded in the data reproduction processing section 18a to be output to the DAC 19a.

The data reproduction processing section 18a decodes the DV frame according to the FF flag and the FS flag of the VAUX data transmitted by the stream controller 15. At this time, the data reproduction processing section 18a outputs the image data to the DAC 19a after a delay of a predetermined period of time that is needed for decoding the DV frame. The DAC 19a transmits the data to be reproduced according to the FS flag and the FF flag of the VAUX data. In the instance of FIG. 6B, the “DV frame #1_TT” is output twice and subsequently the “DV frame #1_BB” is output twice. As a result, the DAC 19a outputs the top field of the DV frame #1 four times and subsequently the bottom field of the DV frame #1 four times. In other words, AUX data are rewritten in such a way that the output frame is switched at a cycle of the period of four fields so that consequently forward slow reproduction is realized at a speed equal to 1/4 of the speed of normal reproduction.

Although not illustrated in FIGS. 6A and 6B, the above description also applies to the frames that follow the DV frame #1. The stream controller 15 prepares copy data of the input DV frame on the buffer memory 16 and rewrites the AUX data so that the field specified by the system controller 21 may be sent out.

Now, a slow reproduction mode where the speed of slow reproduction is equal to the quotient obtained by dividing the speed of normal reproduction by an odd number will be described below. As an example, a processing operation for slow reproduction with a speed that is equal to 1/3 of the speed of normal reproduction will be discussed.

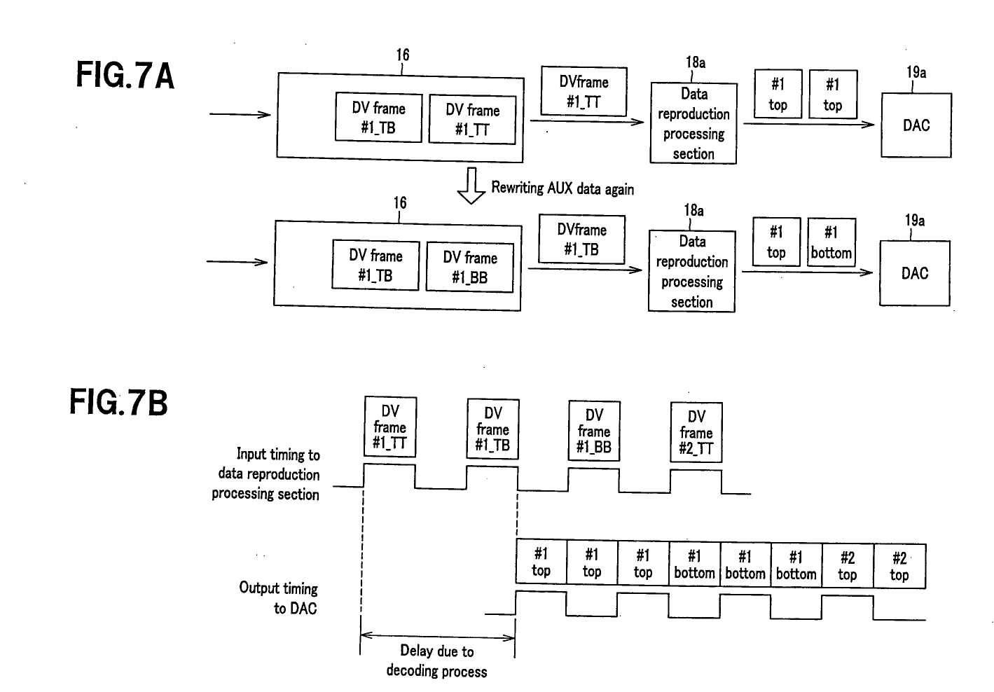

Now, the DV frame obtained after rewriting the AUX data to be transmitted to the data reproduction processing section 18a and the DV data to be decoded by the data reproduction processing section 18a and transmitted to the DAC 19a when the speed of slow reproduction is equal to the quotient obtained by dividing the speed of normal reproduction by an odd number will be described below by referring to FIGS. 7A and 7B.

The AUX data rewriting section 17 generates a frame after rewriting the FF flag and the FS flag of the AUX data of the DV frame #1 so as to read as FF=0 and FS=1 for the DV frame #1 and the DV frame #1′ that is a copy of the DV frame #1 on the buffer memory 16 under the control of the system controller 21. In FIGS. 7A and 7B, the frame for which the FF flag and the FS flag of the AUX data are converted so as to read as FF=0 and FS=1 is expressed by “DV frame #1_TT” and the frame for which the FF flag and the FS flag of the AUX data of the DV frame #1′ are converted so as to read as FF=1 and FS=1 is expressed by “DV frame #1_TB”.

As schematically illustrated in FIG. 7A, the data reproduction processing section 18a decodes the DV frame stored in the buffer memory 16 and transmitted from the stream controller 15 according to the FF flag and the FS flag of the VAUX data contained in the DV frame and transmits it to the DAC 19a. For example, if the DV frame is “DV frame #1_TT”, the top field is output twice because the FF flag and the FS flag of the AUX data read as FF=0 and FS=1. If, on the other hand, the DV frame is “DV frame #1_TB”, the top field and the bottom field are output in the mentioned order because the FF flag and the FS flag of the AUX data read as FF=1 and FS=1.

If the speed of slow reproduction is equal to 1/3 of the speed of normal reproduction, the stream controller 15 reads out the “DV frame #1_TT” and the “DV frame #1_TB generated from the DV frame #1 and the DV frame #1′ that is a copy of the DV frame #1 from the buffer memory 16 and outputs them to the data reproduction processing section 18a. At this time, the stream controller 15 rewrites the FF flag and the FS flag of the AUX data of the “DV frame #1_TT” sent out immediately before on the buffer memory 16 so as to read as FF=0 and FS=0 and newly generates “DV frame #1_BB” in parallel with the operation of transmitting the “DV frame #1_TB” to the data reproduction processing section 18a. The stream controller 15 transmits the “DV frame #1_BB” immediately after the “DV frame #1_TB” to the data reproduction processing section 18a.

Thus, the stream controller 15 sequentially sends out the “DV frame #1_TT” the “DV frame #1_TB” and “DV frame #1_BB” to the data reproduction processing section 18a.

FIG. 7B illustrates the timing for the stream controller 15 to input the DV frame to the data reproduction processing section 18a and the timing for the DV data decoded in the data reproduction processing section 18a to be output to the DAC 19a.

The data reproduction processing section 18a outputs the image data to the DAC 19a after a delay of a predetermined period of time that is needed for decoding the DV frame sent to it. The DAC 19a transmits the data to be reproduced according to the FS flag and the FF flag of the VAUX data. In the instance of FIG. 7B, the “DV frame #1_TT”, the “DV frame #1_TB” and the “DV frame #1_BB” are output to the data reproduction processing section 18a in the mentioned order. The top field of the DV frame #1 is output twice due to the “DV frame #1_TT” and the top field and the bottom file of the DV frame #1 are output in the mentioned order due to the “DV frame #1_TB” to the DAC 19a. Then, the bottom field of the DV frame #1 is output twice to the DAC 19a due to the “DV frame #1_BB”.

Although not illustrated in FIGS. 7A and 7B, after the DV frame #1, the stream controller 15 prepares copy data of the input DV frame on the buffer memory 16 so that the field specified by the system controller 21 may be sent out. In other words, AUX data are rewritten in such a way that the output frame is switched at a cycle of the period of three fields so that consequently forward slow reproduction is realized at a speed equal to 1/4 of the speed of normal reproduction.

A similar process proceeds for reverse slow reproduction. The stream controller 15 reads the DV frame sent from a storage device that can record DV data such as a DV tape or an HDD into the buffer memory 16 and subsequently copies the DV frame, of which the AUX data is rewritten by the AUX data rewriting section 17. At this time, the frames that are output to the data reproduction processing section 18a are switched in such a way that a sequence of “DV frame #n_BB”, “DV frame #n_TT”, “DV frame #(n−1)_BB” and “DV frame #(n−1)_TT” is realized.

It is possible for the user to freely select if the data reproduction apparatus 1 is to be operated at a slow speed of 1/(even number) or 1/(odd number) when an arrangement for speed selection is made in the design stages. For example, it may be so arranged that a slow speed of 1/3 of the normal speed is selected when the user depresses the slow reproduction button once and a slow speed of 1/4 of the normal speed is selected when the user depresses the slow reproduction button twice.

### SPECIFIC EXAMPLE 1-2

### When a Temporary Stop Mode is Specified in a Normal Reproduction Mode

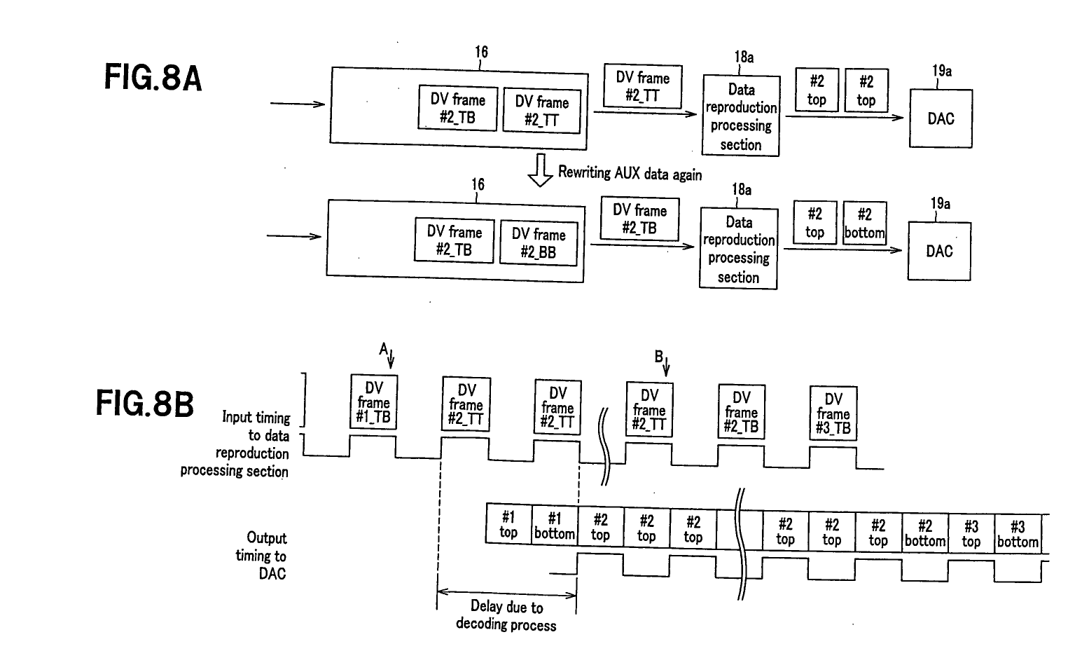

Now, a process of rewriting AUX data for the purpose of generating frames to be output when the data reproduction apparatus 1 is temporarily stopped in an operation of forward normal reproduction will be described below by referring to FIGS. 8A and 8B for the first specific example. FIGS. 8A and 8B schematically illustrate the process of copying a DV frame and rewriting AUX data.

The stream controller 15 of the data reproduction apparatus 1 copies the DV data in the buffer memory 16 and changes the FF flag and the FS flag for specifying the output sequence for the VAUX data of the original DV data and the VAUX data of the copy DV data. When temporary stop is requested while the DV frame #1 is being displayed, the steam coherence 15 changes the FF flag and the FS flag for specifying the output sequence for the VAUX data of the DV frame #2 on the buffer memory 16 so as to fix the AUX data of the DV frame #2 to be displayed next to the top field.

Firstly, the stream controller 15 prepares DV frame #2′ that is a copy of the DV frame #2 on the buffer memory 16. The AUX data rewriting section 17 generates a frame by rewriting the FF flag and the FS flag of the AUX data of the DV frame #2 so as to read as FF=0 and FS=1 for the DV frame #2′ that is a copy of the DV frame #2 on the buffer memory 16 under the control of the system controller 21. In FIGS. 8A and 8B, the frame for which the FF flag and the FS flag of the AUX data are converted so as to read as FF=0 and FS=1 is expressed by “DV frame #2_TT” and the frame for which the FF flag and the FS flag are converted so as to read as FF=1 and FS=1 is expressed by “DV frame #2_TB”.

As schematically illustrated in FIG. 8A, the data reproduction processing section 18a decodes the DV frame stored in the buffer memory 16 and transmitted from the stream controller 15 according to the FF flag and the FS flag of the VAUX data contained in the DV frame and transmits it to the DAC 19a. For example, if the DV frame is “DV frame #2_TT”, the top field is output twice because the FF flag and the FS flag of the AUX data read as FF=0 and FS=1 respectively. If the DV frame is “DV frame #1_TB”, the top field and the bottom field are output in the mentioned order because the FF flag and the FS flag of the AUX data read as FF=1 and FS=1.

FIG. 8B illustrates the timing for the stream controller 15 to input the DV frame to the data reproduction processing section 18a and the timing for the DV data decoded in the data reproduction processing section 18a to be output to the DAC 19a. In FIG. 8B, arrow A indicates that temporary stop is specified and arrow B indicates that temporary stop is lifted.

The data reproduction processing section 18a outputs the image data to the DAC 19a after a delay of a predetermined period of time that is needed for decoding the transmitted DV frame. The DAC 19a transmits the data to be reproduced according to the FS flag and the FF flag of the VAUX data. In the case of temporary stop, the “DV frame #1_TT” is kept on being sent out to the data reproduction processing section 18a until the temporary stop is lifted. The top field of the DV frame #1 is kept on being output to the DAC 19a due to the “DV frame #1_TT”. As a result, the top field of the DV frame #2 is kept on being reproduced so that the reproduced image falls into a temporarily stopped state.

When the temporary stop is lifted, the stream controller 15 sends out the “DV frame #2_TT” and subsequently the “DV frame #2_TB” to the data reproduction processing section 18a. Thereafter, DV frames are sent to the data reproduction processing section 18a in the sequence of DV frame #3, DV frame #4, . . . for normal reproduction. Since DV frame data can be accumulated in the buffer memory 16 during the temporary stop, the DV frame to be displayed next can be decoded quickly and smoothly immediately after the lift of temporary stop.

### SPECIFIC EXAMPLE 1-3

### When a Fast Reproduction Mode is Specified in a Forward Normal Reproduction Mode

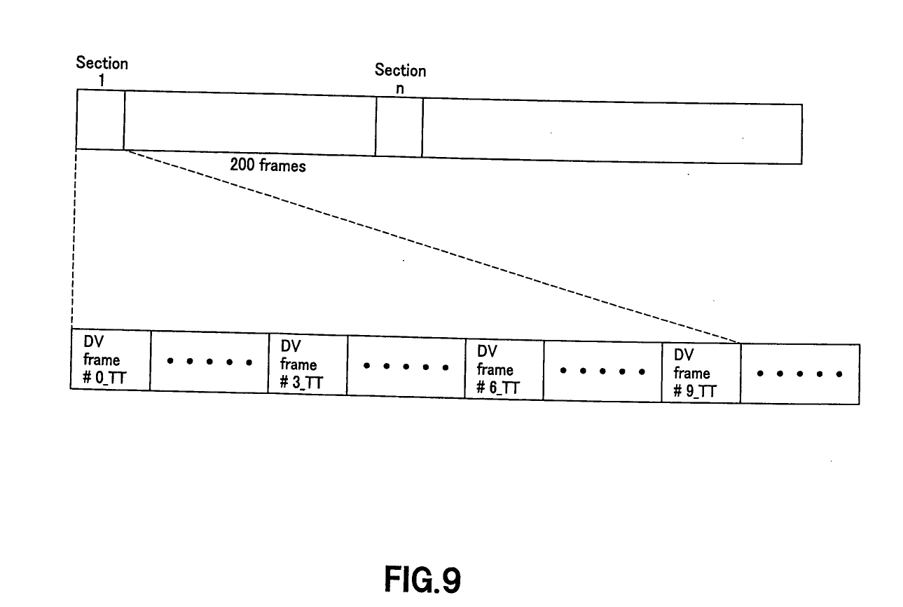

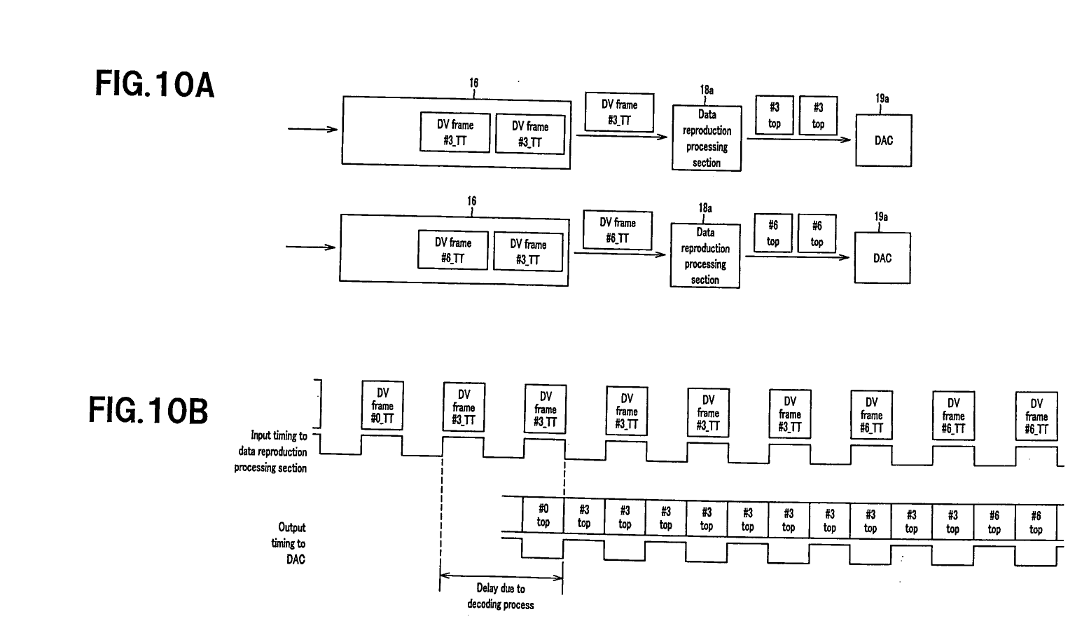

Now, an instance where a fast reproduction mode is specified in a forward normal reproduction mode will be described for the first example. The DV frame after rewriting the AUX data to be sent to the data reproduction processing section 18a and the DV data to be decoded by the data reproduction processing section 18a and sent to the DAC 19a in a fast reproduction mode will be described below by referring to FIGS. 9, 10A and 10B.

FIG. 9 illustrates how data are thinned from the DV data stream transmitted from a storage device so as to be used for fast reproduction. In a fast reproduction mode, the data in each section are thinned for reproduction. For example, in the case of the NTSC system where a section is constituted by ten frames, the storage controller 15 picks up four frames out of the ten frames of a section and uses them for fast reproduction. A section refers to a set of data that the stream controller 15 can transfer from a storage device to the buffer memory 16 at a time.

In this specific example, every three frames of a section including the DV frame #0, the DV frame #3, the DV frame #6 and the DV frame #9 are used. Each of the selected frames is typically used for image display during five frame periods. With this arrangement for thinned reproduction, image data of twenty frame periods can be obtained from each section for the image to be displayed. Therefore, for fast reproduction at a speed ten times faster than the normal speed, the DV data stream of five frame periods to be transferred to the buffer memory 16 next is used for the frame that comes after about 200 frames.

The AUX data rewriting section 17 generates a frame by rewriting the FF flag and the FS flag of the AUX data of the DV frame #3 so as to read as FF=0 and FS=1 for the DV frame #3 and the DV frame #3′ that is a copy of the DV frame #3 on the buffer memory 16 under the control of the system controller 21. In FIGS. 10A and 10B, the FF flag and the FS flag of the AUX data of all the frames including the copies of frames are converted so as to read as FF=0 and FS=1 and all the frames are expressed by “DV frame #3_TT”.

As schematically illustrated in FIG. 10A, the data reproduction processing section 18a decodes the DV frame stored in the buffer memory 16 and transmitted from the stream controller 15 according to the FF flag and the FS flag of the VAUX data contained in the DV frame and transmits it to the DAC 19a. For example, if the DV frame is “DV frame #3_TT”, the top field is output consecutively because the FF flag and the FS flag of the AUX data read as FF=0 and FS=1 respectively.

When an operation of fast reproduction is conducted with the above described technique, the displayed image appears as if it is shaking if the ordinary sequence of top field→bottom field→top field→bottom field is used. Therefore, the DV frame to be used in a fast reproduction mode is fixed to the top field. The stream controller 15 rewrites the AUX data in such a way that the top fields of the DV frames that are selected for thinned reproduction are always output.

For an operation of fast reproduction at a reproduction speed that is equal to ten times of the normal speed, the stream controller 15 reads out the “DV frame #0_TT”, the “DV frame #3_TT”, the “DV frame #6_TT” and the “DV frame #9_TT” that are generated respectively from the DV frame #0, the DV frame #3, the DV frame #6 and the DV frame #9 by converting the FF flags and the FS flags from the buffer memory 16 and transmits each of the frames continuously for five frame periods to the data reproduction processing section 18a.

FIG. 10B illustrates the timing for the stream controller 15 to input the DV frame to the data reproduction processing section 18a and the timing for the DV data decoded in the data reproduction processing section 18a to be output to the DAC 19a.

The data reproduction processing section 18a outputs the image data to the DAC 19a after a delay of a predetermined period of time that is needed for decoding the transmitted DV frame. The DAC 19a transmits the data to be reproduced according to the FS flag and the FF flag of the VAUX data. FIG 10B illustrates that the “DV frame #3_TT” is sent for five frame periods and the “DV frame #6_TT” is sent for five frame periods to the data reproduction processing section 18a. The top field of the DV frame #1 is output twice consecutively for five frame periods due to the #DV frame #3_TT” and hence ten fields are sent to the DAC 19a.

The stream controller 15 transmits the data of the DV frame #n, the DV frame #n+3, the DV frame #n+6 and the DV frame #n+9 prepared on the buffer memory 16 for the section that comes after 200 frames to the field specified by the system controller 21. In other words, it rewrites the AUX data in such a way that the frame to be output after a predetermined period of time is switched at a cycle of 10 field periods. As a result, it is possible to realize fast reproduction at a speed ten times faster than the normal reproduction speed.

### SPECIFIC EXAMPLE 1-4

### When a Forward Normal Reproduction Mode is Specified in a Fast Reproduction Mode

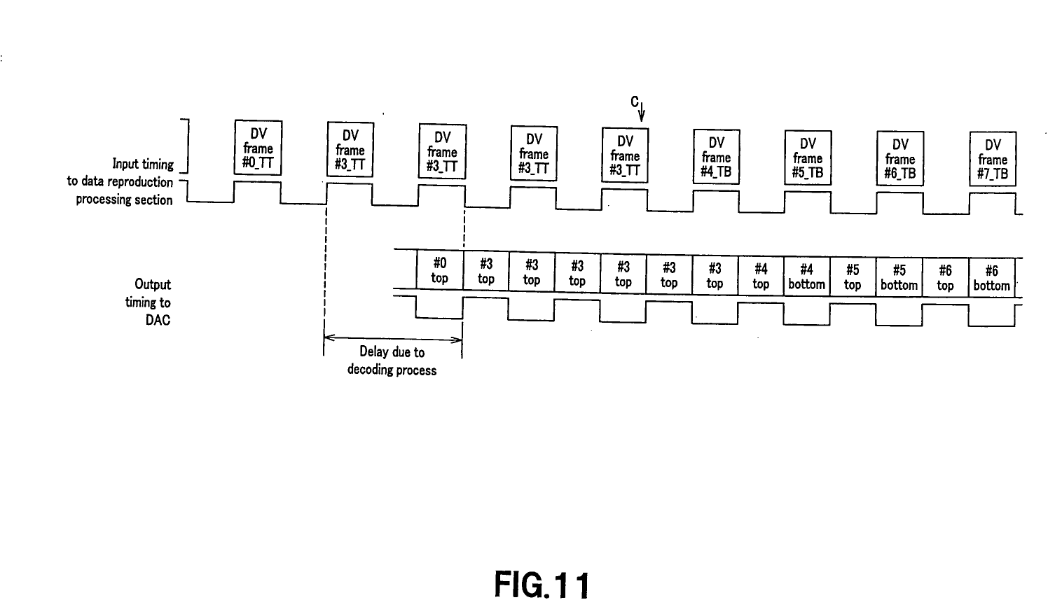

Now, an instance where a forward normal reproduction mode is specified in a fast reproduction mode will be described for the first example. The DV frame after rewriting the AUX data to be sent to the data reproduction processing section 18a and the DV data to be decoded by the data reproduction processing section 18a and sent to the DAC 19a in a fast reproduction mode will be described below by referring to FIG. 11.

As described above by referring to FIGS. 9, 10A and 10B, while the data reproduction apparatus 1 is being operated for fast reproduction, the stream controller 15 generates the “DV frame #0_TT”, the “DV frame #3_TT”, the “DV frame #6_TT” and the “DV frame #9_TT” by converting the FF flags and the FS flags of the DV frame #0, the DV frame #3, the DV frame #6 and the DV frame #9 and keeps them ready in the buffer memory 16.

If the fast reproduction mode is lifted while the DV frame #3 is being displayed for fast reproduction at the timing indicated by arrow C in FIG. 11 subsequent to the operation of FIGS. 9, 10A and 10B, the VAUX data of the DV data #6 and the DV data #9 that are not used in the data for four frames that have been prepared for fast reproduction out of the ten frames transferred to the buffer memory 16 by the stream controller 15 are rewritten so as to release the fixed top fields and use the sequence of top field→bottom field for transmission. In other words, FF=0 and FS=1 are switched to FF=1 and FS=1.

Subsequently, the stream controller 15 transmits DV frames to the data reproduction processing section 18a in the order of the DV frame #4, the DV frame #5, the DV frame #6, . . . for normal reproduction.

As described above, according to the invention, it is now possible to quickly respond to a switch of reproduction mode for selecting a slow reproduction mode, a temporary stop mode, a fast reproduction mode or some other mode by copying the DV frame on the buffer memory 16 and rewriting the flags for specifying the output field. In each of the above described specific examples, the data reproduction processing section 18a that is designed to operate for decoding only has to decode DV data according to FF flags and FS flags. In other words, it is not necessary to operate for setting a reproduction mode and control data streams according to the selected reproduction mode.

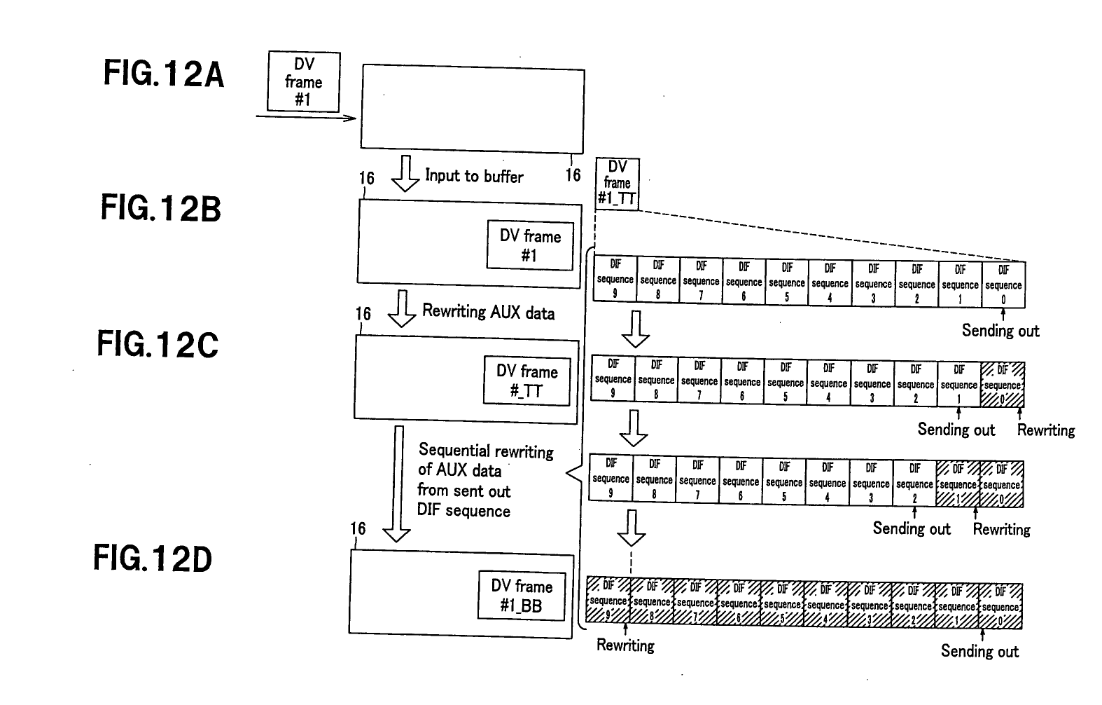

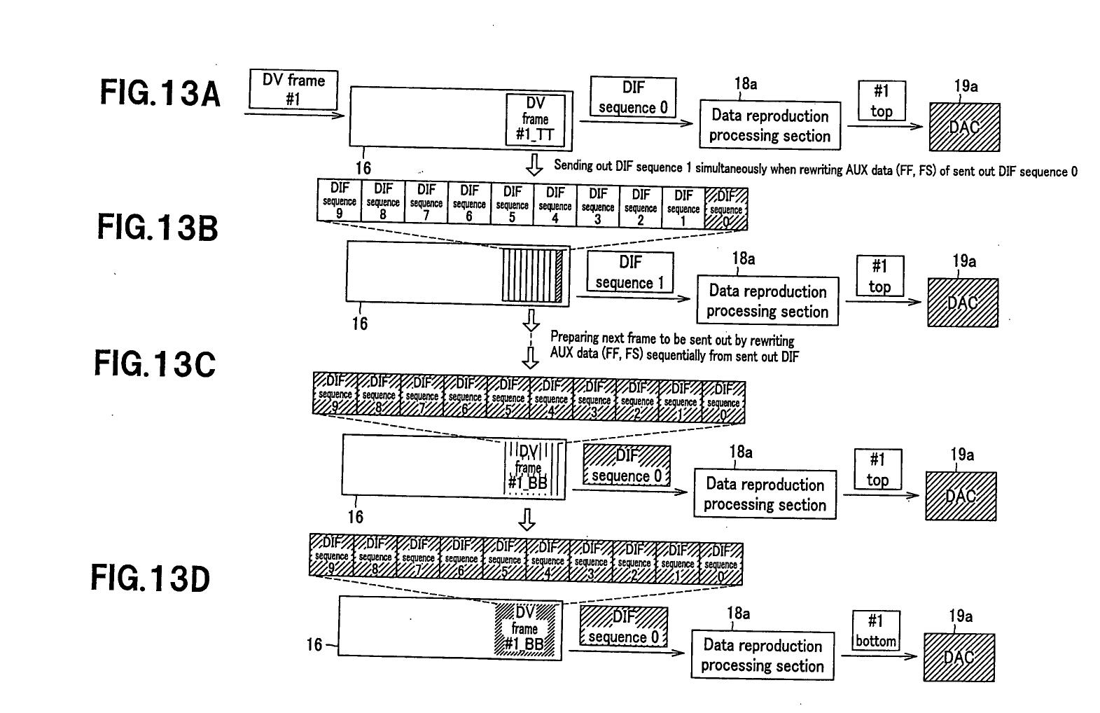

Now, the second specific example of special reproduction process of the data reproduction apparatus 1 will be described by referring to FIGS. 12 and 13. The process of the second specific example is designed to rewrite the plurality of sequences of the original frames into the sequences of the frames to be output, following the original frames, sequentially from the sequence already output to the data reproduction processing section 18.

### SPECIFIC EXAMPLE 2-1

### When a Low Speed Forward Reproduction Mode is Specified in a Forward Normal Reproduction Mode

This is an example of process for rewriting AUX data on the basis of a unit of DIF sequence of frames without copying DV frames on the buffer memory 16. In other words, DIF sequences are sequentially rewritten from the DIF sequence already transmitted to the decoder for the DIF sequence of the frame to be sent out next. With this arrangement, a sequence is prepared for the next frame after a sequence is sent out.

Referring to FIG. 12, the stream controller 15 of the data reproduction apparatus 1 inputs the DV data stream transmitted from a storage device that can record DV data such as a DV tape or an HDD and put DV frame #1, which is a frame of the acquired DV data, into the buffer memory 16 under the control of the system controller 21 (state A→state B in FIG. 12). Then, the AUX data rewriting section 17 rewrites the FF flag and the FS flag of the AUX data of the DV frame #1 so as to read as FF=0 and FS=1 to prepare “DV frame #1_TT” under the control of the system controller 21 (state B→state C in FIG. 12).

The stream controller 15 transmits the top field repeatedly according to the specification given by the “DV frame #1_TT” and sequentially rewrites DIF sequences from the DIF sequence already transmitted for the DIF sequence of the frame to be sent out next, while transmitting the last DV frame of the second transmission (state C→state D in FIG. 12). FIG. 12 illustrates how the FF flag and the FS flag of the AUX data are rewritten so as to read as FF=0 and FS=0 and “DV frame #1_BB” is generated.

FIG. 13 shows a process of sending out a DV frame after rewriting the AUX data, where the stream controller 15 sends out the leading DIF sequence (DIF_Seq0) of the “DV frame #1_BB” that is prepared as the output frame to be transmitted next by rewriting immediately after transmitting the last DIF sequence (DIF_Seq9). At this time, the stream controller 15 rewrites the FF flag and the FS flag of the AUX data of the last DIF sequence (DIF_Seq9) so as to read as FF=0 and FS=0 in parallel with the operation of transmitting the DIF sequence. As a result, the “DV frame #1_BB” is completed. This process is used for the succeeding DV frames. Special reproduction of field precision is realized by way of these processes.

Thus, with the above described data reproduction apparatus 1, it is possible to realize special reproduction of field precision by means of a general purpose decoder without using a decoder having a special feature of field precision. It is also possible to realize special reproduction of field precision without raising the buffer size.

As described above by way of specific examples, it is now possible to realize special reproduction modes such as temporary stop, fast reproduction and slow reproduction that have hitherto been realized by commands issued to the processing section for stream control and DV data decoding only by rewriting the AUX data that specifies the field to be decoded on the buffer memory. Additionally, it is possible to quickly respond to a user request for switching reproduction modes by preparing a DV frame, for which the field to be sent out is specified according to the mode of special reproduction, on the buffer memory.

While the present invention is described in terms of an apparatus adapted to input and reproduce DV data or having a feature of reproducing DV data to be output as reproduction signal to some other apparatus such as display apparatus, it can also be applied to apparatus having a recording feature.

It should be understood by those skilled in the art that various modifications, combinations, sub-combinations and alterations may occur depending on design requirements and other factors insofar as they are within the scope of the appended claims or the equivalents thereof.

1. A data reproduction apparatus comprising:
acquisition means for acquiring digital video data;
temporary memory means for temporarily storing the digital video data acquired by the acquisition means on a frame by frame basis;
output frame generation control means for generating the output frames to be output, following the output of the original frames of the digital video data stored in the temporary memory means, by rewriting the auxiliary data contained in the digital video data and specifying the output image data;
data decoding means for decoding the digital video data according to the auxiliary data; and
output means for externally outputting the digital video data decoded by the data decoding means.

2. The apparatus according to claim 1, wherein the output frame generation control means generates the output frames by copying the original frames in the temporary memory means and rewriting the auxiliary data contained in the original frames and the frames obtained by copying.

3. The apparatus according to claim 2, wherein the output frame generation control means generates the output frames by rewriting the predetermined bit describing the information for determining the field type out of the auxiliary data of the original frames stored in the temporary memory means and the frames obtained by copying.

4. The apparatus according to claim 1, wherein the output frame generation control means generates the output frames by rewriting sequentially from the sequence already output to the data decoding means out of the plurality of sequences of the original frames for the sequences of the frames to be output following the original frames.

5. The apparatus according to claim 4, wherein the output frame generation control means generates the output frames by rewriting the predetermined bit describing the information for determining the field type of the output image data when rewriting sequentially from the sequence already output to the sequences of the frames to be output next.

6. A data reproduction method comprising:
acquiring digital video data;
controlling generation of the output frames to be output, following the output of the original frames of the digital video data stored in a temporary memory means for temporarily storing the digital video data acquired by acquiring digital video data on a frame by frame basis, by rewriting the auxiliary data contained in the digital video data and specifying the output image data;
decoding the digital video data according to the auxiliary data; and
externally outputting the digital video data decoded by decoding the digital video data.

7. The method according to claim 6, wherein the controlling generation of the output frames is adapted to generate the output frames by copying the original frames in the temporary memory means and rewriting the auxiliary data contained in the original frames and the frames obtained by copying.

8. The method according to claim 7, wherein the controlling generation of the output frames is adapted to generate the output frames by rewriting the predetermined bit describing the information for determining the field type out of the auxiliary data of the original frames stored in the temporary memory means and the frames obtained by copying.

9. The method according to claim 6, wherein the controlling generation of the output frames is adapted to generate the output frames by rewriting sequentially from the sequence already decoded by decoding the digital video data out of the plurality of sequences of the original frames for the sequences of the frames to be output following the original frames.

10. The method according to claim 9, wherein the controlling generation of the output frames is adapted to generate the output frames by rewriting the predetermined bit describing the information for determining the field type of the output image data when rewriting sequentially from the sequence already output to the sequences of the frames to be output next.

11. A data reproduction apparatus comprising:
an acquisition section that acquires digital video data;
a temporary memory section that temporarily stores the digital video data acquired by the acquisition section on a frame by frame basis;
an output frame generation control section that generates the output frames to be output, following the output of the original frames of the digital video data stored in the temporary memory section, by rewriting the auxiliary data contained in the digital video data and specifying the output image data;
a data decoding section that decodes the digital video data according to the auxiliary data; and
an output section that externally outputs the digital video data decoded by the data decoding section.

12. A data reproduction method comprising:
an acquisition step of acquiring digital video data;
an output frame generation control step of controlling generation of the output frames to be output, following the output of the original frames of the digital video data stored in a temporary memory means for temporarily storing the digital video data acquired in the acquisition step on a frame by frame basis, by rewriting the auxiliary data contained in the digital video data and specifying the output image data;
a data decoding step of decoding the digital video data according to the auxiliary data; and
an output step of externally outputting the digital video data decoded in the data decoding step.
